(19) United States
(12) Patent Application Publication
(10) Pub. No.: US 2006/0238659 A1
(43) Pub. Date: Oct. 26, 2006

(54) Display unit and fine bubble producing implement

(76) Inventors: Masaru Watanabe, Tokyo (JP); Takeshi Sakuraba, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/546,815

(22) PCT Filed: Feb. 26, 2004
(86) PCT No.: PCT/JP04/02298

§ 371 Date: Aug. 24, 2005

(30) Foreign Application Priority Data
Feb. 28, 2003 (JP) 2003-052496

(51) Int. Cl. H04N 5/74

(52) U.S. Cl. 348/749

(57) ABSTRACT

The invention relates to a display unit in which a plurality of long containers 3 is disposed side by side with the length directed vertically, the long containers 3 containing water, and an air feed pipe 6 corresponding to each long container 3 for feeding air from the bottom of the long container 3 includes: a solenoid valve 7 switched under the control of a controller 11 for feeding and stopping the air supplied from an air pump; a flow controller 8 capable of maintaining the flow rate of the air to be fed at a predetermined value; a check valve 9, the elements being arranged in order in the direction of feed; and an air stone 5 at the end, wherein images are displayed by the microbubbles generated from a filter 5c substantially around the outer periphery of the air stone 5, whereby expressing beautiful images with excellent uniformity and clearness by bubbles.

### TECHNICAL FIELD

The present invention relates to a display unit in which multiple long containers filled with a fluid are disposed side by side, and which displays images such as pictures and characters by bubbles generated in the fluid, and to a microbubble generator.

### BACKGROUND ART

Known techniques for displaying images such as pictures and characters by bubbles generated in a fluid contained in long containers arranged side by side include a display unit disclosed in Patent Document 1 (JP-A-10-260651). The display unit in Patent Document 1 includes a large number of long cylindrical transparent containers filled with a first fluid such as water, at the bottom of which automatic on-off valves are provided for feeding a second fluid having a low specific gravity, such as air. The automatic on-off valves are controlled by a controller, so that any automatic on-off valve is opened for a predetermined time period at any time according to an image signal to generate bubbles of the second fluid in a specified size.

Known techniques for displaying images by bubbles generated in a fluid include a display unit disclosed in Patent Document 2 (JP-A-7-20807). The display unit includes air diffusers in lines at the lower part of a water tank, the air diffusers generating microbubbles by using fine pores or a porous material. Each air diffuser connects to an air supply source via an individual solenoid valve. The solenoid valves is switched under the control of a controller, with a uniform up current of air generated in the water tank, to generate bubble groups by any air diffuser at any time, thereby producing any display pattern.

Another known technique is a display unit disclosed in Patent Document 3 (JP-A-9-311654) in which discharge openings and solenoid valves are provided at the bottom of a water tank filled with a first fluid such as water, and the solenoid valves are opened or closed in a short time to generate bubbles of a second fluid having a specific gravity lower than that of the first fluid through the discharge openings.

### DISCLOSURE OF THE INVENTION

However, the display units disclosed in Patent Documents 1 to 3 supply air or the like throughout by a compressor or the like, thus feeding the air from a feeder into the container merely by on-off control for the solenoid valve. Accordingly, the amount of the air or the like fed from the feeder becomes uneven depending on the feeding interval or the location of the feeder, resulting in uneven size and number of generated bubbles, providing images with insufficient uniformity and clearness.

The display unit disclosed in Patent Document 2 is intended to hold the clearness of the images by generating an up current by regularly generated bubbles or a pump to prevent disturbance, in place of the arrangement having multiple water-containing containers disposed in lines. However, in the case of regularly generating bubbles, unnecessary bubble groups appear, decreasing the clearness of the images; in the case of generating an up current by a pump, an additional pump is required, posing the problem of high cost.

The present invention has been made in light of such circumstances, and has as an object the provision of a display unit in which multiple long containers filled with a fluid are disposed side by side, and which displays images such as pictures and characters by bubbles generated in the fluid, and so can express beautiful images with excellent uniformity and clearness, and it relates to a microbubble generator mainly for use in the display unit.

The display unit according to the invention is characterized in that: a plurality of long containers is disposed side by side with the length directed vertically, the long containers containing a first fluid, and a fluid passage corresponding to each long container for feeding a second fluid having a lower specific gravity than the first fluid from the bottom of the long container includes: at least an on-off valve switched under the control of a controller for feeding and stopping the second fluid supplied from a fluid supply source; a flow controller capable of maintaining the flow rate of the second fluid to be fed substantially at a predetermined value; and a check valve in order in the direction of feed, wherein images are displayed by the bubbles of the second fluid fed into the first fluid. Since the flow rate of the second fluid that forms bubbles is maintained substantially at a predetermined value by the flow controller, bubbles of a substantially uniform size or substantially a predetermined number of bubbles can be formed. Accordingly, beautiful images with excellent uniformity and clearness can be expressed. The multiple long containers disposed side by side may be constructed by partitioning a container by partition plates or the like, or alternatively, may be constructed by arranging multiple separate long containers side by side.

The display unit according to the invention is characterized in that: a microbubble generator is provided at the distal end of the fluid passage, the microbubble generator including: a fluid lead-in tube for leading the second fluid; a fluid reservoir provided at the distal end of the fluid lead-in tube; a filter having substantially a shape of a mortar or the like and provided in the vicinity of the distal end of the fluid lead-in tube and substantially around the outer periphery of the fluid reservoir; and a closed portion of the fluid reservoir at the center of the filter. This allows images such as pictures and characters to be expressed uniformly by microbubbles generated by the microbubble generator. Furthermore, the microbubble generator such as an air stone guides the second fluid and the like to the substantially surrounding filter by the closed portion to generate microbubbles from the substantially mortar-shaped filter. This improves the cut-off of the bubbles of the second fluid and the like, in other words, increases the response speed of feeding and stopping the bubbles as compared with the case in which a substantially spherical filter is disposed around the fluid reservoir and the like, allowing faster expression of images.

The display unit according to the invention is characterized in that: communicating holes for communicating the long containers with one another are provided in the position of the long container, lower than the position from which the bubbles by the second fluid generate, and substantially at the upper part of the long container. This allows the first fluid to move through the communication holes, facilitating maintaining the height of the surface of the first fluid constant in the multiple long containers which are arranged side by side. Forming the communication hole lower than the position from which bubbles are generated prevents the disturbance of image formation by the bubbles. The communication hole may be provided only in the lower position or in the substantially upper position.

A microbubble generator according to the invention is characterized by including: a fluid lead-in tube for leading a fluid; a fluid reservoir provided at the distal end of the fluid lead-in tube; a filter provided in the vicinity of the distal end of the fluid lead-in tube and substantially around the outer periphery of the fluid reservoir; and a closed portion of the fluid reservoir at the center of the filter. The microbubble generator offers the same advantages as those of the above-described microbubble generator.

The display unit according to the invention offers the advantages of maintaining the flow rate of the fluid for forming bubbles at a predetermined value by the flow controller to allow forming of bubbles of a substantially uniform size or substantially a predetermined number of bubbles, thus expressing beautiful images with excellent uniformity and clearness. Furthermore, the microbubble generator generates microbubbles from the substantially surrounding filter. This improves the cut-off and generation of the bubbles of the fluid to increase the response speed of feeding and stopping the bubbles, allowing faster expression of images.

The microbubble generator according to the invention guides a fluid to the substantially surrounding filter by the closed portion, and feeds the fluid from the filter to generate microbubbles, whereby improving the cut-off and generation of the microbubbles of the fluid, thus increasing the response speed of feeding and stopping the bubbles.

### BRIEF DESCRIPTION OF THE DRAWINGS

FIG. 1 is an explanatory diagram of a display unit according to an embodiment;

FIG. 2(a) is a front view of a water tank in the display unit of FIG. 1;

FIG. 2(b) is a cross-sectional view taken along arrow A-A in FIG. 2(a);

FIG. 3(a) is a plan view of an air stone in the display unit according to the embodiment; and

FIG. 3(b) is a longitudinal sectional view of the air stone in FIG. 3(a).

### BEST MODE FOR CARRYING OUT THE INVENTION

A display unit according to an embodiment of the invention will be described with reference to the drawings.

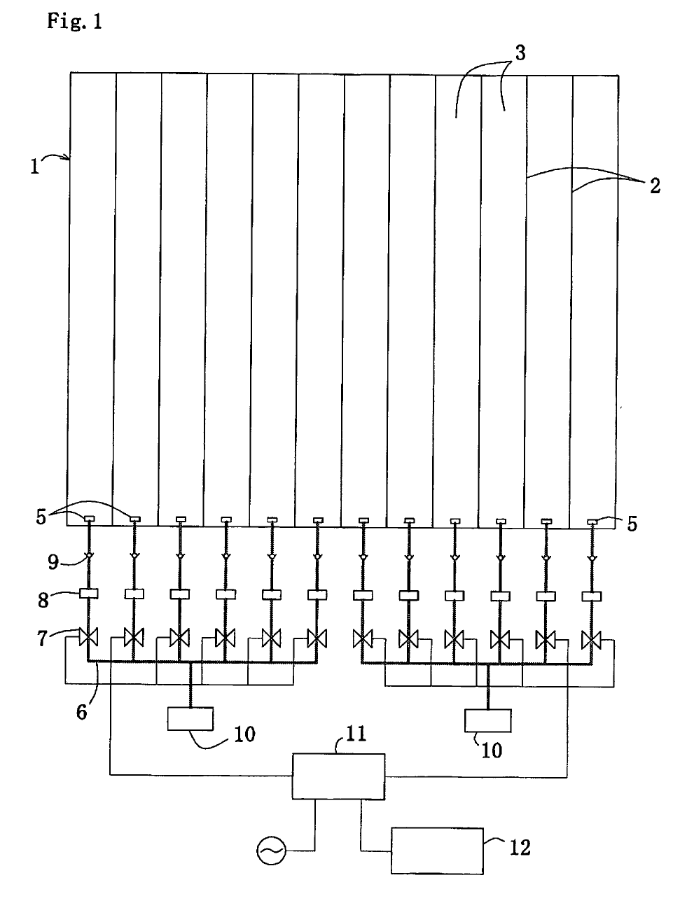

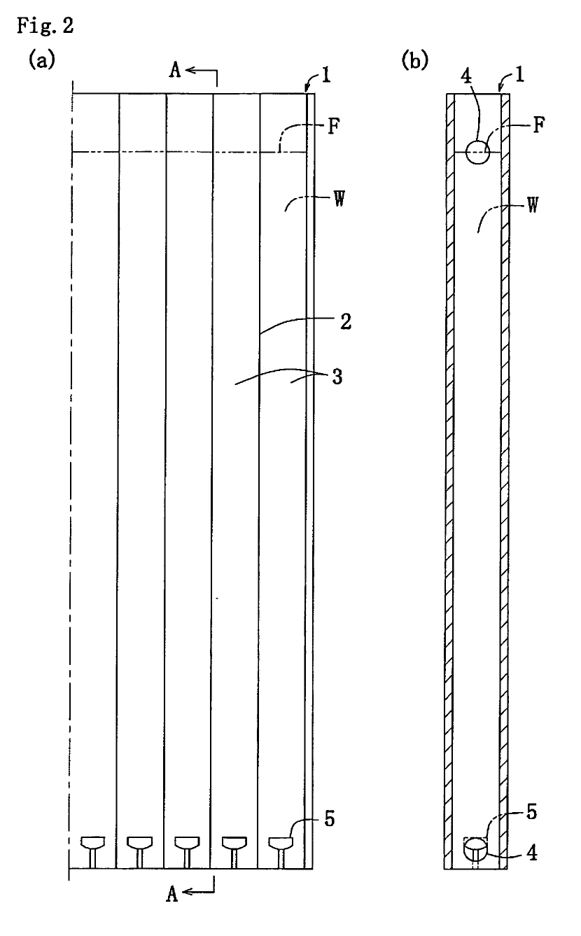

As shown in FIGS. 1 and 2, the display unit according to the embodiment includes a substantially planar transparent water tank 1 serving as a screen, in which long partition plates 2 are provided to construct substantially rectangular-parallelepiped vertically long containers 3, the long containers 3 being disposed laterally side by side. The long containers 3 is filled with water W corresponding to a first fluid close to the upper end, so that the long containers 3 contains the water W. Each partition plate 2 has communication holes 4 in position at substantially upper part and lower part, which communicate the long containers 3 with one another, so that, when water is poured to a position above the lower end of the communication hole 4 in the substantially upper part, the water levels F of the long containers 3 become equal. The communication hole 4 at the substantially lower part is located below the upper surface of a filter 5c of an air stone 5 from which bubbles, to be described later, are generated.

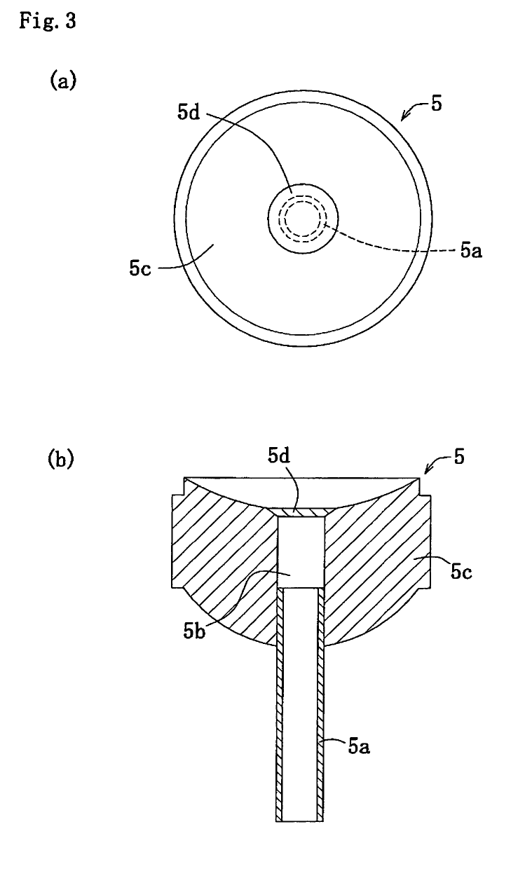

At the bottom of each long container 3, the air stone 5 serving as the feeder of air corresponding to a second fluid is provided. As shown in FIG. 3, the air stone 5 has an air reservoir 5b at the distal end of an air lead-in tube 5a for leading air. Around the vicinity of the distal end of the air lead-in tube 5a and the substantially outer periphery of the air reservoir 5b, a ring-shaped or substantially mortar-shaped filter 5c having a hole in the center is provided. The filter 5c is made of a porous material or the like and is used to divide air that passed through the filter 5c to generate microbubbles. Furthermore, a closed portion 5d made of an adhesive or the like is provided at the upper end of the air reservoir 5b, which is the upper end of the central hole of the filter 5c. Air led from the air lead-in tube 5a to the air reservoir 5b is guided by the closed portion 5d at the upper end to the surrounding filter 5c, thereby generating microbubbles from the surrounding filter 5c.

The air lead-in tube 5a of the air stone 5 connects to the distal end of an air feed pipe 6 branching in correspondence with each long container 3. The branch air feed pipe 6 includes a solenoid valve 7 which is switched under the control of the controller 11 to feed or stop the air, a flow controller 8 that can maintain the flow rate of the air to be fed at a predetermined value, such as a flow limiting orifice that limits the upper limit of air flow, and a check valve 9 in order in the direction of feeding air. The air feed pipe 6 is supplied with air from an air pump 10 or a compressor. Furthermore, a regulator (not shown) is disposed immediately in front of the check valve 9 of the air feed pipe 6 to keep the pressure of air to be supplied constant.

The air in the air feed pipe 6 is present to the position of the check valve 9 all the time, and is increased in pressure by opening the solenoid valve 7 to open the check valve 9 against water pressure, thus being fed into the long containers 3. Since the air is present to the position of the check valve 9 all the time, generation of bubbles is enhanced to increase the response speed. Preferably, decreasing the distance between the solenoid valve 7 and the check valve 9 as much as possible facilitates air compression, further increasing the response speed.

The controller 11 includes a controller; a memory that stores a predetermined program and data, such as predetermined check time, opening time, a virtual pixel region, and a set image; a timer that measures the predetermined check time and opening time; and other necessary elements, and stores data, for example, on a virtual pixel region in which pixels are arranged in matrix, corresponding to a screen constructed of the long containers 3 arranged side by side.

When the controller 11 is set in a set-image process mode, it is determined for the set image in the pixel region for each line at specified check time intervals whether a pixel having opening data is present in the pixels in any line, wherein when a pixel having opening data is present, the solenoid valve 7 corresponding to the pixel is opened for a predetermined opening time period. The determination is executed in sequence from the head line located at the uppermost end of the pixel region to the endmost line at the lowermost end, and the procedure returns to the head line after it is executed to the endmost line. It is also possible to set an image received from a terminal 12, to be described later, as a set image in a memory. The controller 11 may be provide with an image display section and an input section, and an inputted image may be displayed substantially in real time by the controller 11 by recognizing the opening data in each pixel from the inputted image.

The controller 11 is connected to the terminal 12 by wire or radio as necessary. Also the terminal 12 has substantially the same structure as the controller 11, and includes a controller; a memory that stores a predetermined program and data, such as predetermined check time, opening time and a virtual pixel region; a timer that measures the predetermined check time and opening time; and other necessary elements, and stores data, for example, on a virtual pixel region in which pixels are arranged in matrix, corresponding to a screen constructed of the long containers 3 arranged in lines.

When the controller 11 is set in a received-image process mode, it is determined for the input image in the pixel region for each line at specified check time intervals whether a pixel having opening data is present in the pixels in any line, wherein when a pixel having opening data is present, data for opening the solenoid valve 7 corresponding to the pixel for a predetermined opening time period is sent to the controller 11. The determination is executed in sequence from the head line located at the uppermost end of the pixel region to the endmost line at the lowermost end, and the opening data is sent in sequence according to the determination, and then the procedure returns to the head line after it is executed to the endmost line. The controller 11 opens the solenoid valve 7 corresponding to the opening data that is received or is received in sequence for a predetermined opening time. Such a structure allows an image inputted to the pixel region by the remote terminal 12 to be displayed on a display unit substantially in real time.

When displaying images on the display unit according to the embodiment, a predetermined solenoid valve 7 is opened by the controller 11 or under the temporal control by the controller 11 and the terminal 12. In response to the opening of the solenoid valve 7, air that was controlled to a predetermined flow rate by the flow controller 8 opens the check valve 9 and goes toward the air stone 5. In the air stone 5, the introduced air is guided to the filter 5c substantially around the outer periphery, most of which is fed through the substantially arc cross-section substantially concave or substantially planar upper surface of the filter 5c into the long container 3 corresponding to the solenoid valve 7 as microbubbles. Thus an image in a specified pattern, such as a picture or a character, is displayed on a screen constructed of the arranged long containers 3 according to the opening pattern of the solenoid valve 7 corresponding to the long container 3.

The display unit can maintain the flow rate of air for forming bubbles constant by the flow controller 8 to form substantially a predetermined number of bubbles, thereby expressing a beautiful image with excellent uniformity and clearness. Since the display unit expresses one pixel by multiple or many microbubbles, temporarily combined pixels do not become unsightly as distinct from the case of expressing one pixel by one bubble. Furthermore, the air stone 5 guides the air to the substantially surrounding filter 5c by the closed portion 5d to generate microbubbles from the substantially concave upper surface of the filter 5c, and the air is present to the position of the check valve 9 all the time. This increases the response speed of the cut-off and generation of the air, allowing faster expression of images.

It is preferable that the long containers 2 or the water tank 1 that constructs the screen of the display unit allow images by bubbles to be viewed; both surface or one surface may be transparent or semitransparent. While the embodiment has been described for the case in which the first fluid is water and the second fluid is air, any other fluids can be used for the first fluid and the second fluid as long as the second fluid has a lower specific gravity than the first fluid. The microbubble generator is not limited to the air stone 5, but may be any other that can generate microbubbles.

### INDUSTRIAL APPLICABILITY

The invention can be applied to a display unit that displays images such as pictures and characters by bubbles generated in a fluid.

1. A display unit characterized in that: a plurality of long containers is disposed side by side with the length directed vertically, the long containers containing a first fluid, and a fluid passage corresponding to each long container for feeding a second fluid having a lower specific gravity than the first fluid from the bottom of the long container includes:
at least an on-off valve switched under the control of a controller for feeding and stopping the second fluid supplied from a fluid supply source; a flow controller capable of maintaining the flow rate of the second fluid to be fed substantially at a predetermined value; and a check valve, the elements being arranged in order in the direction of feed, wherein images are displayed by the bubbles of the second fluid fed into the first fluid.

2. The display unit according to claim 1, characterized in that: a microbubble generator is provided at the distal end of the fluid passage, the microbubble generator including: a fluid lead-in tube for leading the second fluid; a fluid reservoir provided at the distal end of the fluid lead-in tube; a filter provided in the vicinity of the distal end of the fluid lead-in tube and substantially around the outer periphery of the fluid reservoir; and a closed portion of the fluid reservoir at the center of the filter.

3. The display unit according to claim 1 or 2, characterized in that: communicating holes for communicating the long containers with one another are provided in the position of the long container, lower than the position from which the bubbles by the second fluid generate, and substantially at the upper part of the long container.

4. A microbubble generator characterized by comprising: a fluid lead-in tube for leading a fluid; a fluid reservoir provided at the distal end of the fluid lead-in tube; a filter provided in the vicinity of the distal end of the fluid lead-in tube and substantially around the outer periphery of the fluid reservoir; and a closed portion of the fluid reservoir at the center of the filter.
